(19) United States
(12) Patent Application Publication
(10) Pub. No.: US 2026/0341160 A1
(43) Pub. Date: Oct. 29, 2026

(54) Machine and Process to Reduce Atmospheric Warming

(71) Applicant: The Boeing Company, Arlington, VA (US)

(72) Inventors: Emily Schwartz DALLARA, Seattle, WA (US); Stephen Solomon ALTUS, Campbell, CA (US); Colin TULLY, Menlo Park, CA (US)

(21) Appl. No.: 19/186,794

(22) Filed: Apr. 23, 2025

(51) Int. Cl. G08G 5/32; G08G 5/76

(52) U.S. Cl. CPC G08G 5/32; G08G 5/76

(57) ABSTRACT

Embodiments herein illustrate a process and machine configured to reduce contrail production by an aerospace vehicle engine, wherein the machine comprises an Altullara configured to: receive atmospheric data for a portion of a planned route for an aerospace vehicle; derive a prediction of a contrailing ice supersaturated region for an altitude for a portion of the planned route; transform a route planning algorithm based upon a bias derived from the prediction of the ice supersaturated region to the altitude for the portion of the planned route; form an Elicon route at or above 3,000 feet below the tropopause with a transformed route planning algorithm; and load the Elicon route into a flight control computer configured to fly the aerospace vehicle along the Elicon route.

### BACKGROUND INFORMATION

### 1. Field

The present disclosure relates generally to a machine and process to reduce atmospheric warming and in particular, to a machine and process to reduce production of a contrail by an aerospace vehicle.

### 2. Background

A problem exists where persistent contrails from aerospace vehicles are contributing to warming of the Earth’s atmosphere. Exhaust from an engine of an aerospace vehicle contains water vapor, which can condense and freeze into ice crystals when the surrounding air is cold enough. These ice crystals may reflect sunlight and be visible in what is called a contrail. If the atmosphere is dry, the ice crystals sublimate quickly, resulting in short-lived contrails.

However, if the exhaust occurs in a contrailing ice supersaturated region (CISSR) where the air is sufficiently cold to form a contrail with ice supersaturation for contrail persistence and the relative humidity with respect to ice is greater than 100%, the water vapor in the exhaust can condense and freeze, creating a contrail that persists. As a result, water vapor from the surrounding atmosphere may also condense and freeze, leading to an expansion of a persistent contrail. As used herein, persistent means lasting more than a couple of minutes. Persistent contrails can extend for hundreds of meters in height and several kilometers in length. Persistent contrails can also develop into contrail cirrus, which are thin, wispy clouds that can cover a large area.

Contrails and contrail cirrus can have a warming effect on the climate by trapping outgoing radiation from Earth, similar to the greenhouse effect. The climate impact of contrails may be significant, and some studies suggest that the atmospheric warming effect from persistent contrails may be comparable to the impact of direct CO₂ emissions from aviation.

The European Union is beginning to monitor the impact of contrails formed by aerospace vehicle flights as part of the non-CO₂ Monitoring, Reporting, and Verification program. Airspace regulators may impose restrictions to numbers and/or routes of flights authorized and/or fees based in part upon contrail contribution to climate change.

Current contrail avoidance decision support tools for aerospace vehicle flights assume that contrail forecast accuracy at one flight level is independent of forecast accuracy at other flight levels. Current contrail avoidance flight path guidance is determined via route selections that may consider current contrail forecasts. Current contrail avoidance flight path guidance may include 4D avoidance polygon regions for areas with predicted contrail formation conditions. Current contrail avoidance flight path guidance may include 4D varying contrail cost factors included that currently are likely to suggest horizontal or vertical deviations. CISSRs typically are laterally wide (typically about 150 km long) and vertically thin (less than 3,000 feet). Current flight planning systems may suggest horizontal deviations if practical, and when horizontal deviations are not practical (when 4D avoidance region is extensive), to planning, at approximately equal rates, upward or downward shifts in flight level for the aerospace vehicle.

Therefore, it would be desirable to have a machine and/or process that take into account at least some of the issues discussed above, as well as other possible issues. For example, it would be desirable to have a machine and/or process that overcome a technical problem with formation of persistent contrails by aerospace vehicle flights.

### SUMMARY

An embodiment of the present disclosure provides a machine and process for reducing warming of the Earth’s atmosphere. The process may include: receiving, in an Altullara, atmospheric data for a portion of a planned route for an aerospace vehicle; deriving, in the Altullara, a prediction of a contrailing ice supersaturated region for an altitude for a portion of the planned route; transforming a route planning algorithm by applying a bias derived from the prediction of the ice supersaturated region to the altitude for the portion of the planned route; forming an Elicon route with a transformed route planning algorithm; loading the Elicon route into a flight control computer; and flying the aerospace vehicle along the Elicon route.

The process for reducing warming of the Earth’s atmosphere may also include the atmospheric data being received from a weather service. The atmospheric data may be received from the aerospace vehicle in proximity to the planned route. The process may also include deriving the bias based upon historical data for the planned route and/or deriving the prediction of a contrailing ice supersaturated region in real-time.

Without limitation, in the process for reducing warming of the Earth’s atmosphere the flight control computer may be connected to an autopilot system flying the aerospace vehicle along the Elicon route. The process may also include updating the Elicon route in real-time. The route planning algorithm may incorporate: aerospace vehicle performance limits, weather conditions, fuel efficiency, cruise time of the planned route, and air traffic control restrictions. The bias may favor a climb when the altitude for the portion of the planned route is at or above 3,000 feet below a tropopause.

In the process for reducing warming of the Earth’s atmosphere, the portion may be for a cruise phase of the planned route. The Altullara may be integrated into a flight planning system. The Altullara may be a separate unit from and in communication with a flight planning system.

According to other illustrative embodiments described herein, a process for reducing a formation of a contrail by an aerospace vehicle is also provided The process may include: receiving, in an Altullara, atmospheric data for a portion of a planned route for an aerospace vehicle; deriving, in the Altullara, a prediction of a contrailing ice supersaturated region for an altitude for a portion of the planned route; transforming a route planning algorithm by applying a bias derived from the prediction of the ice supersaturated region to the altitude for the portion of the planned route; forming an Elicon route with a transformed route planning algorithm; loading the Elicon route into a flight control computer; and flying the aerospace vehicle along the Elicon route. The process may also include deriving the bias based upon historical data for the planned route and/or deriving the prediction of a contrailing ice supersaturated region and updating the Elicon route in real-time.

For the process for reducing a formation of a contrail by an aerospace vehicle, the flight control computer may be connected to an autopilot system executing the Elicon route. The route planning algorithm may incorporate: aerospace vehicle performance limits, weather conditions, fuel efficiency, cruise time of the planned route, and air traffic control restrictions. The bias may favor a climb when the altitude for the portion of the planned route is at or above 3,000 feet below a tropopause. The portion may be for a cruise phase of the planned route.

Hence, described herein is an embodiment of a machine that may include an Altullara configured to: receive atmospheric data for a portion of a planned route for an aerospace vehicle; derive a prediction of a contrailing ice supersaturated region for an altitude for a portion of the planned route; transform a route planning algorithm based upon a bias derived from the prediction of the ice supersaturated region to the altitude for the portion of the planned route; form an Elicon route with a transformed route planning algorithm; and load the Elicon route into a flight control computer configured to fly the aerospace vehicle along the Elicon route.

The features and functions can be achieved independently in various embodiments of the present disclosure or may be combined in yet other embodiments in which further details can be seen with reference to the following description and drawings.

### BRIEF DESCRIPTION OF THE DRAWINGS

The novel features believed characteristic of the illustrative embodiments are set forth in the appended claims. The illustrative embodiments, however, as well as a preferred mode of use, further objectives and features thereof, will best be understood by reference to the following detailed description of an illustrative embodiment of the present disclosure when read in conjunction with the accompanying drawings, wherein:

FIG. 1 is a pictorial representation of a machine and process to avoid forming a persistent contrail that contributes to warming of the Earth’s atmosphere, in accordance with an illustrative embodiment;

FIG. 2 is a flowchart for a process for reducing warming of the Earth’s atmosphere in accordance with an illustrative embodiment;

FIG. 3 is a flowchart for a process for reducing a formation of a contrail by an aerospace vehicle in accordance with an illustrative embodiment;

FIG. 4 is an illustration of a block diagram of a data processing system, in accordance with an illustrative embodiment;

FIG. 5 is an illustration of an aircraft manufacturing and service method, in accordance with an illustrative embodiment;

FIG. 6 is an illustration of a block diagram of an aircraft in which an illustrative embodiment may be implemented; and

FIG. 7 is an illustration of a block diagram of a product management system, in accordance with an illustrative embodiment.

### DETAILED DESCRIPTION

Illustrative embodiments herein recognize and take into account one or more different considerations as described herein. Persistent contrails, or long-lasting condensation trails, form in regions of contrailing ice supersaturation (CISSR) when aircraft engine exhaust water vapor condenses and freezes, creating ice crystals that can persist for hours, potentially developing into contrail cirrus clouds.

Illustrative embodiments herein recognize and take into account that research (such as by Petzold in 2020) have shown that it is rare for aircraft to generate contrails above the tropopause. Current contrail avoidance system contrail forecasts are programmed independently for each flight level. Current flight planning systems and flight operations are not applying research indication of effects of altitude relative to the tropopause on probability of ice supersaturation and the formation of persistent contrails.

Illustrative embodiments herein recognize and take into account that based on analysis of 5-minute flight segments for a group of commercial aircraft over North America for a 1-year period in the Reanalysis Tropopause Data Repository, only about 1/3 of Google contrail-predicted flight segments were flown above 3,000 feet below the tropopause. Recent research (such as by Meijer in 2024) shows that when a forecast for a persistent contrail is wrong for one altitude, there is a high likelihood that the contrail forecasts at nearby altitudes in the same location are also wrong. Research shows that CISSR regions may extend less than 2,000 feet in altitude. Despite currently pervasive programming for current contrail avoidance via shifts of altitude for a flight, the recent research indicates those altitude shifts are often ineffective because when a forecast for formation of persistent contrails at one altitude in a region is wrong, then current forecasts regarding persistent contrails at neighboring altitudes in that region are likely to also be wrong. Thus, current flight planning system programs to reduce persistent contrail formation by aircraft in flight have been less successful in actual flights than expected.

Illustrative embodiments herein recognize and take into account that as contrail environmental and regulatory impacts are assigned to operators of contrail forming aircraft, there may be more environmental and commercial benefit derived from reducing aircraft flight impact on climate warming via contrail avoidance.

Illustrative embodiments herein recognize and take into account that research data from operations on commercial long-range aircraft by the In-service Aircraft of a Global Observing System (IAGOS) developed for monitoring the atmospheric composition, and its predecessor, the Measurement of OZone and water vapour on Airbus In-service airCraft (MOZAIC), indicate that chances of encountering an CISSR decrease significantly as altitude increases from above 3,000 feet below the tropopause. Hence statistical probabilities for encountering persistent contrails at altitudes relative to the tropopause exist. Statistically, a flight 3,000 feet below the tropopause increase a likelihood of encountering a CISSR by 50 percent more than its likelihood at the tropopause. A flight just 1,400 feet above the tropopause may be 1/2 as likely to encounter a CISSR as a flight at the tropopause. The likelihood of a flight 3,000 feet or more above the tropopause encountering a CISSR is near zero. Current contrail forecasting and route selection programs do not incorporate statistical probabilities produced from these studies.

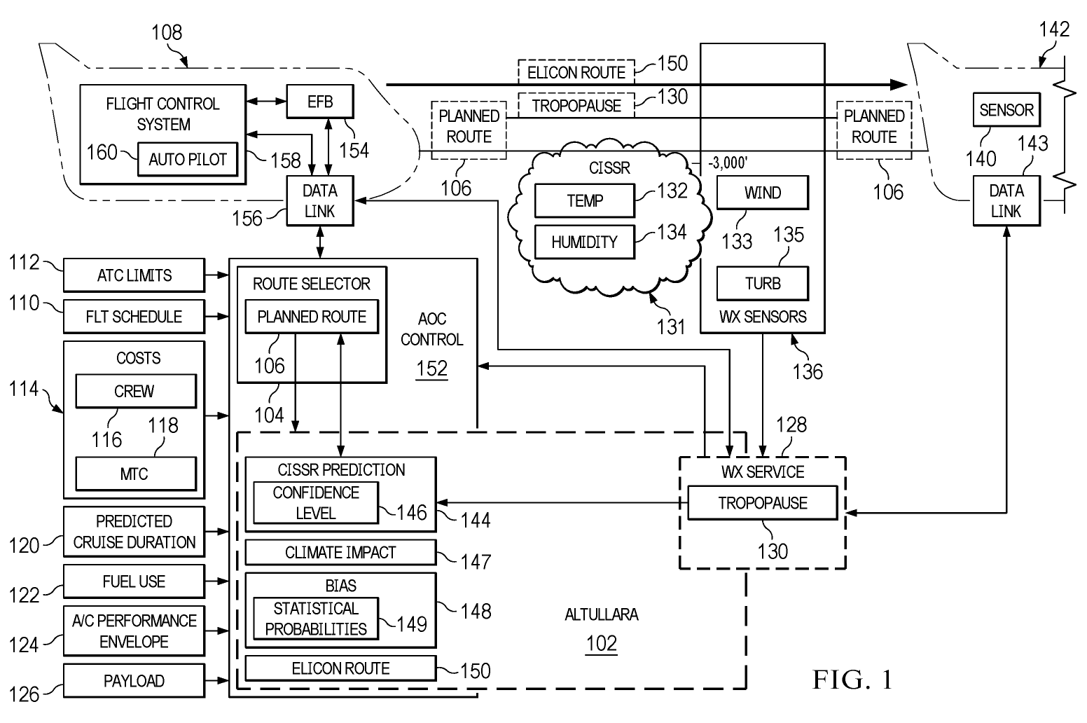

With reference now to the figures and, in particular, with reference to FIG. 1, a pictorial representation of a machine and process to avoid forming a persistent contrail that contributes to warming of the Earth’s atmosphere is depicted in accordance with an illustrative embodiment. More specifically, Altullara 102 provides an algorithm that produces a novel and probabilistic forecast for formation of persistent contrails for each flight level along planned route 106.

Altullara 102 is a formal name for a specially programmed processor that has novel programmed code that forms algorithms that transform algorithms from present processor and/or program codes of route selector 104 that derive planned route 106 for aircraft 108 flying flight schedule 110. In FIG. 1, aircraft 108 represents any aerospace vehicle (manned or unmanned) that may fly with an engine that may produce a contrail. Flight (Flt) schedule 110 includes a departure location and time and an arrival location and time (not shown).

Route selector 104 is representative of a flight planning processor/network that may currently be available to derive planned route 106 based upon factors that may include, without limitation for planned route 106: air traffic control limits 112, operating costs 114 that may include, without limitation, cost for crew 116 and/or cost for maintenance (MTC) 118, predicted cruise duration 120, fuel use 122, A/C performance envelope 124 for aircraft 108, payload 126 of aircraft 108, and/or information from weather service 128. Information from weather (WX) service 128 may include, without limitation, a level of tropopause 130 as well as temperature (TEMP) 132, wind 133, humidity 134, and/or turbulence (TURB) 135, along with other parameters measured by weather (WX) sensors 136.

Without limitation, weather sensors 136 may include: launched weather balloons, satellite technology, and/or sensor 140 within aerospace vehicle 142 in the vicinity of planned route 106. Without limitation, aerospace vehicle 142 may be similar to aircraft 108. Weather sensors 136 and/or data link 143 in aerospace vehicle 142 may transmit information about atmospheric data to weather service 128, or directly into Altullara 102. Without limitation, aerospace vehicle 142 may include any object in airspace that may affect planned route 106 for aircraft 108. Without limitation another aerospace vehicle 142 may be manned or unmanned, commercial, private, military, or government operated. Aerospace vehicle 142 may have data link 143 configured to transmit and/or receive at least with weather service 128 and/or Altullara 102. Aircraft 108 may also be considered as another aerospace vehicle 142 to a flight that is not flown by aircraft 108. Hence, (not shown) aircraft 108 may also have a unit to sense weather like sensor 140 present in aerospace vehicle 142 and transmit and/or receive at least with weather service 128 and/or Altullara 102 through at least data link 156.

Portions of planned route 106 may be planned as a cruise phase of flight between initial climb from a departure airport and descent down to a destination airport. A portion of cruise phase may be planned at a differing altitude from other portions of cruise phase. Without limitation, portions of cruise phase may be designated by waypoints along planned route 106.

Weather service 128 may be, without limitation, the National Oceanic and Atmospheric Administration, or other providers, such as without limitation Google, and/or any service used by an operator of aerospace vehicle 142 and/or aircraft 108. Weather service 128 may provide atmospheric data, which may include without limitation: wind 133, temperature 132, humidity 134, and/or turbulence 135, for a number of altitudes, and/or a level of tropopause 130 for waypoints along planned route 106 to route selector 104.

As used herein, “a number of” when used with reference to items, means one or more items. For example, “a number of different types of networks” is one or more different types of networks.

Further, the phrase “at least one of,” when used with a list of items, means different combinations of one or more of the listed items can be used, and only one of each item in the list may be needed. In other words, “at least one of” means any combination of items and a number of items may be used from the list, but not all of the items in the list are required. The item can be a particular object, a thing, or a category.

For example, without limitation, “at least one of item A, item B, or item C” may include item A, item A and item B, or item B. This example also may include item A, item B, and item C or item B and item C. Of course, any combination of these items can be present. In some illustrative examples, “at least one of” can be, for example, without limitation, two of item A; one of item B; and ten of item C; four of item B and seven of item C; or other suitable combinations.

Weather service 128 may also provide without limitation: temperature 132, wind 133, humidity 134, and/or turbulence 135, for a number of altitudes, and/or a level of tropopause 130 for points along planned route 106 directly to Altullara 102. Weather service 128, route selector 104, and/or Altullara 102 may receive and use information from weather service 128 along with all inputs to route selector 104 to derive a forecast for predicting a location of contrailing ice supersaturated region (CISSR) 131 for all points along cruise portion of planned route 106. CISSR prediction 144 defines location as well as altitude levels and confidence level 146 at each altitude level for generation of persistent contrails if aircraft 108 flies at a flight level within CISSR prediction 144. Without limitation, Altullara 102 may accept an external prediction system CISSR prediction 144. However, unlike current flight planning systems, such as without limitation route selector 104, Altullara 102 does not treat CISSR prediction 144 as being certain or independent. Specially programmed novel algorithms in Altullara 102 use all weather service 128 inputs but - unlike current flight planning systems – do not treat weather service 128 forecasts of supersaturated icing conditions as being certain and altitude independent. Instead, Altullara 102 applies a forecast accuracy analysis producing confidence level 146 to forecasts at each altitude to derive CISSR prediction 144 for each altitude for each portion of planned route 106 and factor that in as a part of bias 148 applied to derive Elicon route 150. Altullara 102 generates a non-binary probabilistic bias 148.

In other words, the Altullara 102 provides a technological improvement over current flight planning systems that provides a more accurate matrix that selects a flight level that is more likely to reduce formation of persistent contrails by aircraft 108 executing flight schedule 110. Unlike current flight planning systems, Altullara 102 does not assume that weather service 128 (or other current sourced) forecasts for CISSR 131 is certain or that forecasts for each altitude are based upon independent errors. Altullara 102 knows inputs and forecast data may have errors and that some of those errors may not be independent. Altullara 102 uses all available information – including both an uncertain contrail forecast and information about altitudes relative to tropopause 130 - to provide probabilities and decision guidance, such as without limitation Elicon route 150, that will lead to a best environmental outcome.

Altullara 102 may also include a specially programmed climate impact 147 algorithm that estimates, presents, and may factor into Elicon route 150 selection contrail warming climate impact 147 on the Earth’s atmosphere based upon Altullara 102 CISSR prediction 144. Without limitation, climate impact 147 may also be presented or transmitted for display on/by Altullara 102 at AOC control 152, in electronic flight bag (EFB) 154, to regulators, or elsewhere.

Additionally, there are lateral variations in a height of tropopause 130. Thus, it is possible that for two similar aircraft 108 at the same flight level but separated horizontally by some distance, one aircraft 108 may be at the tropopause 130 and another aerospace vehicle 142 may be above or below the tropopause 130. Accordingly, Altullara 102 may also determine that a horizontal deviation is likely to avoid CISSR 131 in part because of the lateral variations in the tropopause 130 height, as well as the forecast temperature 132 and humidity 134.

Altullara 102 may also apply bias 148 that may transform programing within route selector 104 and/or modify output of route selector 104 to produce Elicon route 150 in place of planned route 106. Elicon route 150 is a novel formal name given to a specially programmed route to be flown by aircraft 108 (representing any version of any vehicle in the atmosphere with an engine that produces a contrail) to eliminate contrail generation of a persistent nature by aircraft 108. Elicon route 150 may retain portions that are identical to planned route 106. Elicon route 150 may change location of planned route 106 in order to minimize production of persistent contrails by aircraft 108 flying flight schedule 110. Change to location of planned route 106 may include a change of flight level to be flown by aircraft 108. Elicon route 150 as shown relative to tropopause 130 in FIG. 1 is not limited to specific altitude or relationship to tropopause 130 as shown in FIG. 1. Although Elicon route 150 bias 148 favors flight levels (altitudes) above tropopause 130, dependent upon constraints, including without limitation any of inputs 110-126, Elicon route 150 may be lower than 3,000 feet below the tropopause 130.

Bias 148 does not eliminate consideration of, without limitation: air traffic control limits 112 112, operating cost 114 that may include without limitation crew 116 costs 116 and/or maintenance costs (MTC) 118, time for predicted cruise duration 120, fuel use 122, A/Claim performance envelope 124 for aircraft 108, payload 126 of aircraft 108, and/or information from weather service 128, but alters their influence by adding weighting based upon confidence level 146 for CISSR prediction 144 in an algorithm(s) deriving Elicon route 150. Bias 148 applies probabilistic influences on forecasts for persistent contrails that applies latest research on statistical probabilities 149 for formation of persistent contrails based upon flight level relative to tropopause 130.

Thus, where horizontal deviations of planned route 106 cannot practically avoid CISSR 131, Altullara 102 may evaluate all altitudes adjacent to the planned route 106 from 3,000 feet below the tropopause 130 up to a performance limited altitude of aircraft, and derive a change in the probability of producing persistent contrails for each of the altitudes adjacent to the planned route 106 from 3,000 feet below the tropopause 130 up to a performance limited altitude of aircraft. The Altullara 102 then, in conjunction with evaluations for all inputs to route selector 104, computes a change in each of those inputs (such as without limitation: fuel use 122, flight schedule 110, and cruise duration 120) for each of the altitudes adjacent to the planned route 106 from 3,000 feet below the tropopause 130 up to a performance limited altitude of aircraft 108 to derive a most favorable altitude to satisfy as best able all the desired outcomes for each of the parameters/inputs for the flight, and from those results and operator assigned weightings for each of the parameters, determines Elicon route 150. A listing of any changes for any parameters evaluated may also be presented in text and/or chart/graph/table format (not shown) if desired for each altitude available. Without limitation, presentation could be on: a user interface associated with route selector 104, Altullara 102, and/or electronic flight bag 150, or another display associated with flight control system 158 for aircraft 108.

In other words, not only will Altullara 102 generate Elicon route 150 and transmit it to datalink 156 on aircraft, but may also present for review parameters utilized in determining Elicon route 150, and a listing of parameters from evaluation for each other altitude not selected. These computations and presentations are performed for any portions of a cruise portion of planned route 106 that intersect a forecast potential CISSR 131. Without limitation, a portion of a cruise portion of planned route 106 may be defined as a segment between two waypoints on planned route 106.

Altullara 102 may be an independent processor that acts upon programming of route selector 104. Hence, physically, Altullara 102 may be located as an independent processor. Alternatively, Altullara 102 may be integrated within route selector 104 and integrally or additively operate to transform functionalities of route selector 104. Thus, Altullara 102 may be physically located along side, within, or separated from route selector 104, which may without limitation be located in processor and/or processing network at Air Operations Center (AOC) Control 152 or within electronic flight bag (EFB) 154 in aircraft. AOC control 152 in FIG. 1 may represent a physical location and/or a processing network that may be considered to represent and/or be a part of a flight planning system. Without limitation, flight planning system may be located in AOC control 152, EFB 154, or other enroute tools.

Furthermore, Altullara 102 can automatically, and/or by manual commands, update Elicon route 150 in real-time whenever a new forecast with a CISSR 131 forecast is received. Similarly, an update of Altullara 102 Elicon route 150 computation can be initiated by an input from aircraft 108, such as without limitation through EFB 154 or a flight management computer control display unit. Hence, if aircraft 108 is producing and/or observes persistent contrails in a region, and/or at an altitude not forecast to produce contrails, and desires a new altitude in real-time to stop producing contrails, a new computation of Elicon route 150 by Altullara 102 can be requested. Likewise, air operations center control 152 can input a request for a real-time update of Elicon route 150. Such requests from aircraft 108 and/or air operations center control 152 will produce Elicon route 150 with a new presentation with evaluations for all inputs to route selector 104 with computed changes to each of those inputs (such as without limitation: fuel use 122, flight schedule 110, and predicted cruise duration 120) for each of the altitudes adjacent to the planned route 106 from 3,000 feet below the tropopause 130 up to a performance limited altitude of aircraft 108 to derive a most favorable altitude to satisfy as best able all the desired outcomes for each of the parameters/inputs for the flight.

Aircraft 108 may communicate with Altullara 102 and/or AOC control 152 and/or weather service 128 through, without limitation, data link 156. Thus, Elicon route 150 may be loaded into flight control system 158 158 for aircraft. Autopilot 160 may then control aircraft 108 to fly along Elicon route 150. Without limitation, an operator may also use guidance from Elicon route 150 to fly aircraft 108 along Elicon route 150.

Hence, herein an embodiment is shown of a machine configured to reduce contrail production by an engine of aircraft 108 and/or aerospace vehicle 142, wherein the machine comprises an Altullara 102 configured to: receive atmospheric data for a portion of a planned route 106 for an aerospace vehicle 142; derive a prediction of a contrailing ice supersaturated region for an altitude for a portion of the planned route 106; transform a route planning algorithm based upon a bias 148 derived from the prediction of the ice supersaturated region to the altitude for the portion of the planned route 106; form an Elicon route 150 with a transformed route planning algorithm; and load the Elicon route 150 into a flight control computer configured to fly the aerospace vehicle 142 along the Elicon route 150. Without limitation, flight control computer may be located on aerospace vehicle 142 or away from aerospace vehicle 142 and connected to control aerospace vehicle 142 in flight through data link.

In other words, the Altullara 102 provides higher confidence of a successful contrail avoidance outcome than current route planning systems incorporating altitude relative to the tropopause 130 along with other factors to determine Elicon route 150. Hence a technological advantage in reducing warming of the Earth’s atmosphere is provided over current route selection machines and/or processes by using the Altullara 102 over relying only on the contrail forecast (as done today), where currently one is likely to shift altitudes and still make a contrail at that new altitude. Using Altullara 102, one is less likely to make a contrail at the new altitude on Elicon route 150 as compared to flying planned route 106 produced by only route selector 104 without Altullara 102.

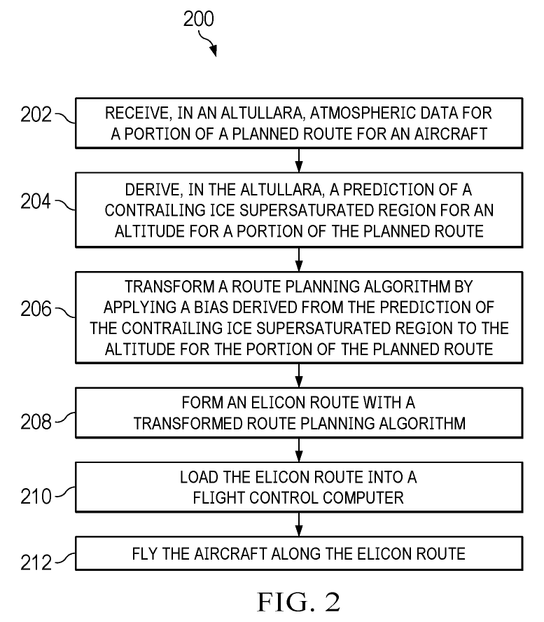

Turning now to FIG. 2, FIG. 2 is a flowchart for a process for reducing warming of the Earth’s atmosphere in accordance with an illustrative embodiment. More specifically, FIG. 2 illustrates process 200 for reducing warming of the Earth’s atmosphere that may begin with receiving, in an Altullara, atmospheric data for a portion of a planned route for an aircraft (operation 202); deriving, in the Altullara, a prediction of a contrailing ice supersaturated region for an altitude for a portion of the planned route (operation 204); transforming a route planning algorithm by applying a bias derived from the prediction of the ice supersaturated region to the altitude for the portion of the planned route (operation 206); forming an Elicon route with a transformed route planning algorithm (operation 208); loading the Elicon route into a flight control computer (operation 210); and flying the aircraft along the Elicon route (operation 212). For process 200, the atmospheric data may be received from a weather service. The bias may be derived from historical data associated with the planned route. The atmospheric data may be received from aircraft in proximity to the planned route. Without limitation, historical data may include research data collected through IAGOS, or since that study as collected by WX service 128, and/or aerospace vehicle 142 and/or operators thereof.

Process 200 may also include deriving the prediction of a contrailing ice supersaturated region in real-time. The flight control computer may be connected to an autopilot system executing the Elicon route. Process 200 may include updating the Elicon route in real-time. The route planning algorithm may incorporate: aircraft performance limits, weather conditions, fuel efficiency, cruise time of the planned route, and/or air traffic control restrictions.

Process 200 may include the bias favoring a climb when the altitude for the portion of the planned route is at or above 3,000 feet below a tropopause. The portion may be for a cruise phase of the planned route. The Altullara may be integrated into a flight planning system or the Altullara may be a separate unit from and in communication with a flight planning system. Without limitation, flight planning system may be located in AOC control, electronic flight bag, or other enroute tools.

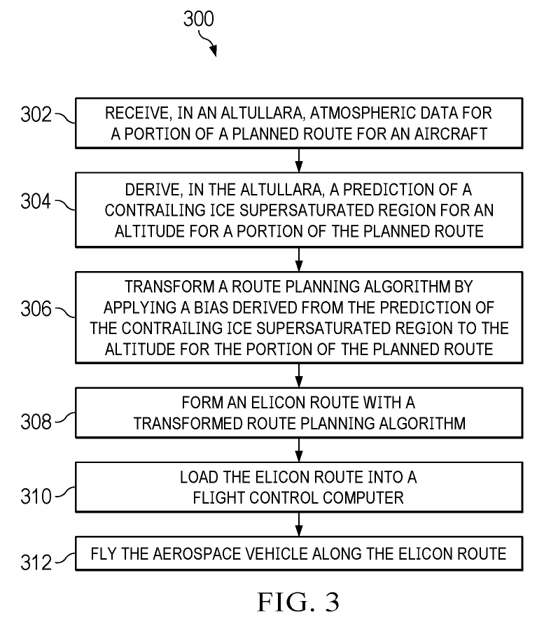

Now turning to FIG. 3, FIG. 3 is a flowchart for a process for reducing a formation of a contrail by an aerospace vehicle in accordance with an illustrative embodiment. More specifically, process 300 for reducing a formation of a contrail by an aerospace vehicle may begin by receiving, in an Altullara, atmospheric data for a portion of a planned route for an aircraft (operation 302).

Process 300 may continue with deriving, in the Altullara, a prediction of a contrailing ice supersaturated region for an altitude for a portion of the planned route (operation 304); transforming a route planning algorithm by applying a bias derived from the prediction of the ice supersaturated region to the altitude for the portion of the planned route (operation 306); forming an Elicon route with a transformed route planning algorithm (operation 308); loading the Elicon route into a flight control computer (operation 310); and flying the aerospace vehicle along the Elicon route (operation 312). The bias may be derived from historical data associated with the planned route.

Process 300 may also include deriving the prediction of a contrailing ice supersaturated region and updating the Elicon route in real-time. The flight control computer may be connected to an autopilot system executing the Elicon route. The route planning algorithm may incorporate: aerospace vehicle performance limits, weather conditions, fuel efficiency, cruise time of the planned route, and air traffic control restrictions.

For process 300, the bias may favor a climb when the altitude for the portion of the planned route is at or above 3,000 feet below a tropopause. The portion may be for a cruise phase of the planned route.

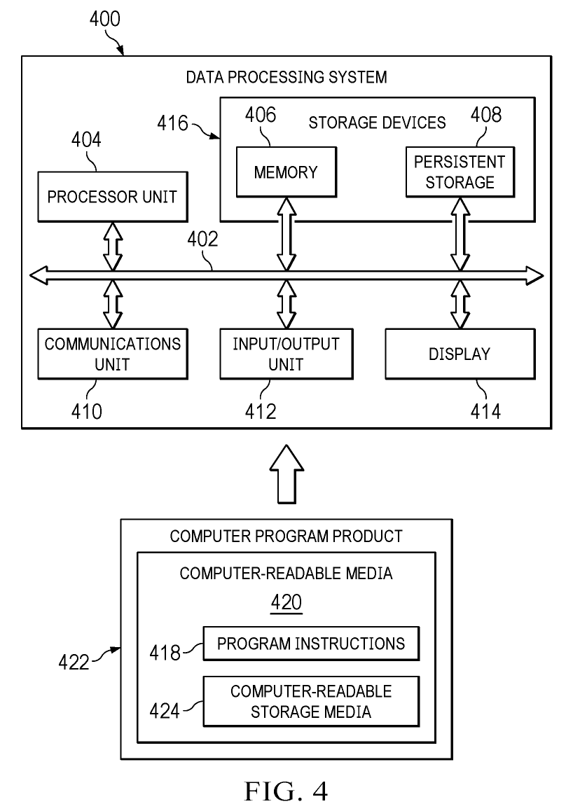

Turning now to FIG. 4, a block diagram of a data processing system is depicted in accordance with an illustrative embodiment. Without limitation, data processing system 400 may be considered as a nonlimiting illustration any of the processors shown, described, and/or required in FIGS. 1-3. Without limitation, processing system 400 may be representative of at least, without limitation, any of: Altullara 102, EFB 154, parts of flight control system 158, AOC control 152 and/or route selector 104. In this illustrative block diagram, data processing system 400 includes communications framework 402, which provides communications between processor unit 404, memory 406, persistent storage 408, communications unit 410, input/output (I/O) unit 412, and display 414. In this illustration, communications framework 402 takes the form of a bus system.

Processor unit 404 serves to execute instructions for software that can be loaded into memory 406. Processor unit 404 includes one or more processors. For illustration, processor unit 404 can be selected from at least one of a multicore processor, a central processing unit (CPU), a graphics processing unit (GPU), a physics processing unit (PPU), a digital signal processor (DSP), a network processor, or some other suitable type of processor. Further, processor unit 404 can be implemented using one or more heterogeneous processor systems in which a main processor is present with secondary processors on a single chip. As another illustrative illustration, processor unit 404 can be a symmetric multi-processor system containing multiple processors of the same type on a single chip.

Memory 406 and persistent storage 408 are illustrations of storage devices 416. A storage device is any piece of hardware that is capable of storing information, such as, for illustration, without limitation, at least one of data, program instructions in functional form, or other suitable information either on a temporary basis, a permanent basis, or both on a temporary basis and a permanent basis. Storage devices 416 may also be referred to as computer-readable storage devices in these illustrative illustrations. Memory 406, in these illustrations, can be, for illustration, a random-access memory or any other suitable volatile or non-volatile storage device. Persistent storage 408 may take various forms, depending on the particular implementation.

For illustration, persistent storage 408 may contain one or more components or devices. For illustration, persistent storage 408 can be a hard drive, a solid-state drive (SSD), a flash memory, a rewritable optical disk, a rewritable magnetic tape, or some combination of the above. The media used by persistent storage 408 also can be removable. For illustration, a removable hard drive can be used for persistent storage 408.

Communications unit 410, in these illustrative illustrations, provides for communications with other data processing systems or devices. In these illustrative illustrations, communications unit 410 is a network interface card.

Input/output unit 412 allows for input and output of data with other devices that can be connected to data processing system 400. For illustration, input/output unit 412 may provide a connection for user input through at least one of a keyboard, a mouse, or some other suitable input device. Further, input/output unit 412 may send output to a printer. Display 414 provides a mechanism to display information to a user.

Instructions for at least one of the operating system, applications, or programs can be located in storage devices 416, which are in communication with processor unit 404 through communications framework 402. The processes of the different embodiments can be performed by processor unit 404 using computer-implemented instructions, which may be located in a memory, such as memory 406.

These instructions are referred to as program instructions, computer usable program instructions, or computer-readable program instructions that can be read and executed by a processor in processor unit 404. The program instructions in the different embodiments can be embodied on different physical or computer-readable storage media 424, such as memory 406 or persistent storage 408.

Program instructions 418 are located in a functional form on computer-readable media 420 that is selectively removable and can be loaded onto or transferred to data processing system 400 for execution by processor unit 404. Program instructions 418 and computer-readable media 420 form computer program product 422 in these illustrative illustrations. In the illustrative illustration, computer-readable media 420 is computer-readable storage media 424.

Computer-readable storage media 424 is a physical or tangible storage device used to store program instructions 418 rather than a medium that propagates or transmits program instructions 418. Computer-readable storage media 424 may be at least one of an electronic storage medium, a magnetic storage medium, an optical storage medium, an electromagnetic storage medium, a semiconductor storage medium, a mechanical storage medium, or other physical storage medium. Some known types of storage devices that include these mediums include: a diskette, a hard disk, a random access memory (RAM), a read-only memory (ROM), an erasable programmable read-only memory (EPROM or Flash memory), a static random access memory (SRAM), a compact disc read-only memory (CD-ROM), a digital versatile disk (DVD), a memory stick, a floppy disk, a mechanically encoded device, such as punch cards or pits / lands formed in a major surface of a disc, or any suitable combination thereof.

Computer-readable storage media 424, as that term is used in the present disclosure, is not to be construed as storage in the form of transitory signals per se, such as at least one of radio waves or other freely propagating electromagnetic waves, electromagnetic waves propagating through a waveguide, light pulses passing through a fiber optic cable, electrical signals communicated through a wire, or other transmission media.

Further, data can be moved at some occasional points in time during normal operations of a storage device. These normal operations include access, de-fragmentation or garbage collection. However, these operations do not render the storage device as transitory because the data is not transitory while the data is stored in the storage device.

Alternatively, program instructions 418 can be transferred to data processing system 400 using a computer-readable signal media. The computer-readable signal media are signals and can be, for illustration, a propagated data signal containing program instructions 418. For illustration, the computer-readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

Further, as used herein, “computer-readable media 420” can be singular or plural. For illustration, program instructions 418 can be located in computer-readable media 420 in the form of a single storage device or system. In another illustration, program instructions 418 can be located in computer-readable media 420 that is distributed in multiple data processing systems. In other words, some instructions in program instructions 418 can be located in one data processing system while other instructions in program instructions 418 can be located in one data processing system. For illustration, a portion of program instructions 418 can be located in computer-readable media 420 in a server computer while another portion of program instructions 418 can be located in computer-readable media 420 located in a set of client computers.

The different components illustrated for data processing system 400 are not meant to provide architectural limitations to the manner in which different embodiments can be implemented. In some illustrations, one or more of the components may be incorporated in or otherwise form a portion of, another component. For illustration, memory 406, or portions thereof, may be incorporated in processor unit 404 in some illustrations. The different illustrative embodiments can be implemented in a data processing system including components in addition to or in place of those illustrated for data processing system 400. Other components shown in FIG. 4 can be varied from the illustrative illustrations shown. The different embodiments can be implemented using any hardware device or system capable of running program instructions 418.

In the illustrations, the hardware can take a form selected from at least one of a circuit system, an integrated circuit, an application-specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Without limitation, programmable logic devices may include: a programmable logic array, a programmable array logic, a field-programmable logic array, a field-programmable gate array, and other suitable hardware devices. Additionally, the processes can be implemented in organic components integrated with inorganic components and can be comprised entirely of organic components excluding a human being. Without limitation, the processes can be implemented as circuits in organic semiconductors.

The flowcharts and block diagrams in the different depicted embodiments illustrate the architecture, functionality, and operation of some possible implementations of apparatuses and methods in an illustrative embodiment. In this regard, each block in the flowcharts or block diagrams can represent at least one of a module, a segment, a function, or a portion of an operation or step. Without limitation, one or more of the blocks can be implemented as program instructions, hardware, or a combination of the program instructions and hardware. When implemented in hardware, the hardware can, for illustration, take the form of integrated circuits that are manufactured or configured to perform one or more operations in the flowcharts or block diagrams. When implemented as a combination of program instructions and hardware, the implementation may take the form of firmware. Each block in the flowcharts or the block diagrams can be implemented using special purpose hardware systems that perform the different operations or combinations of special purpose hardware and program instructions run by the special purpose hardware.

In some alternative implementations of an illustrative embodiment, the function or functions noted in the blocks may occur out of the order noted in the figures. Without limitation, in some cases, two blocks shown in succession may be performed substantially concurrently, or the blocks may sometimes be performed in the reverse order, depending upon the functionality involved. Also, other blocks may be added in addition to the illustrated blocks in a flowchart or block diagram.

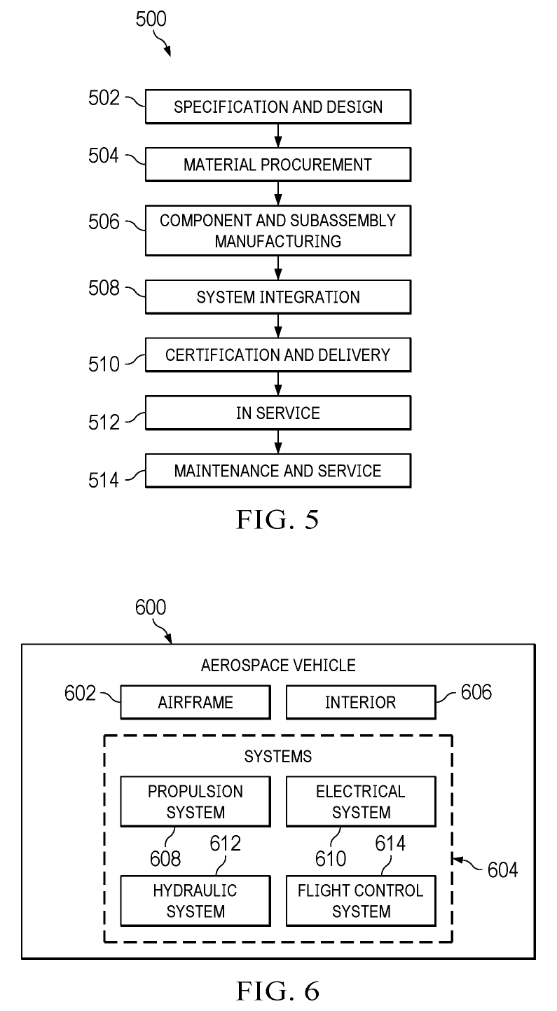

Illustrative embodiments of the disclosure may be described in the context of aircraft manufacturing and service method 500 as shown in FIG. 5 and aerospace vehicle 600 as shown in FIG. 6. Aerospace vehicle 600 may be representative of aircraft 108 (as mentioned above, aerospace vehicle 142 may also be similar to aircraft 108) shown in FIG. 1. Aircraft manufacturing and service method 500 may also be representative of manufacturing and service of parts on and/or controlling or associated with aerospace vehicle 600 such as, without limitation, Altullara 102. Hence, in description below for FIG. 5, references to aerospace vehicle 600 may also be applied to Altullara 102.

Turning first to FIG. 5, an illustration of an aircraft manufacturing and service method is depicted in accordance with an illustrative embodiment. During pre-production, aircraft manufacturing and service method 500 may include specification and design 502 of aerospace vehicle 600 in FIG. 6 and material procurement 504.

During production, component and subassembly manufacturing 506 and system integration 508 of aerospace vehicle 600 in FIG. 6 takes place. Thereafter, aerospace vehicle 600 in FIG. 6 can go through certification and delivery 510 in order to be placed in service 512. While in service 512 by a customer, aerospace vehicle 600 in FIG. 6 is scheduled for routine maintenance and service 514, which may include modification, reconfiguration, refurbishment, and other maintenance or service.

Each of the processes of aircraft manufacturing and service method 500 may be performed or carried out by a system integrator, a third party, an operator, or some combination thereof. In these illustrations, the operator may be a customer. For the purposes of this description, a system integrator may include, without limitation, any number of aircraft manufacturers and major-system subcontractors; a third party may include, without limitation, any number of vendors, subcontractors, and suppliers; and an operator may be an airline, a leasing company, a military entity, a service organization, and so on.

With reference now to FIG. 6, an illustration of an aircraft is depicted in which an illustrative embodiment may be implemented. In this illustration, aerospace vehicle 600 is produced by aircraft manufacturing and service method 500 in FIG. 5 and may include airframe 602 with plurality of systems 604 and interior 606. Without limitation, systems 604 include one or more of propulsion system 608, electrical system 610, hydraulic system 612, and flight control system 614. Flight control system 614 may be considered representative of flight control system 158 shown in FIG. 1. Altullara 102 may be considered as a part of airframe 602 and/or a part of flight control system 614. Any number of other systems may be included such as at least, without limitation, communications including data link 156.

Apparatuses and methods embodied herein may be employed during at least one of the stages of aircraft manufacturing and service method 500 in FIG. 5. Without limitation, components or subassemblies produced in component and subassembly manufacturing 506 in FIG. 5 can be fabricated or manufactured in a manner similar to components or subassemblies produced while aerospace vehicle 600 is in service 512 in FIG. 5. As yet another illustration, one or more apparatus embodiments, method embodiments, or a combination thereof can be utilized during production stages, such as component and subassembly manufacturing 506 and system integration 508 in FIG. 5. One or more apparatus embodiments, method embodiments, or a combination thereof may be utilized while aerospace vehicle 600 is in service 612, during maintenance and service 514 in FIG. 5, or both. Retrofit of Altullara 102 onto an existing aerospace vehicle 600 may be considered as a portion of maintenance and service 514. The use of a number of the different illustrative embodiments may substantially expedite the assembly of aerospace vehicle 600, reduce the cost of aerospace vehicle 600, or both expedite the assembly of aerospace vehicle 600 and reduce the cost of aerospace vehicle 600.

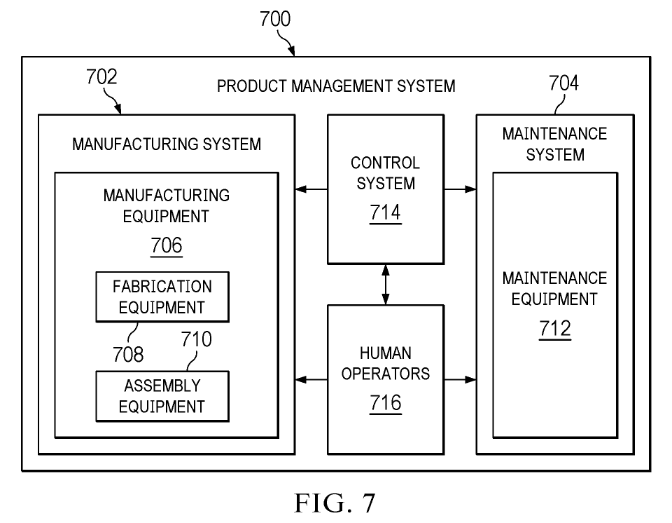

Turning now to FIG. 7, an illustration of a block diagram of a product management system is depicted in accordance with an illustrative embodiment. Product management system 700 is a physical hardware system. In this illustration, product management system 700 includes at least one of manufacturing system 702 or maintenance system 704.

Manufacturing system 702 is configured to manufacture products, such as aerospace vehicle 600 in FIG. 6 and/or Altullara 102 in FIG. 1. As depicted, manufacturing system 702 includes manufacturing equipment 706. Manufacturing equipment 706 includes at least one of fabrication equipment 708 or assembly equipment 710 for manufacture of Altullara 102.

Fabrication equipment 708 is equipment that is used to fabricate components or parts, such as , without limitation, Altullara 102 used to form aerospace vehicle 600 in FIG. 6, which is representative of aircraft 108 in FIG. 1. Without limitation, fabrication equipment 708 can include machines and tools. These machines and tools can be at least one of: a drill, a hydraulic press, a furnace, an autoclave, a mold, a composite tape laying machine, an automated fiber placement (AFP) machine, a vacuum system, a robotic pick and place system, a flatbed cutting machine, a laser cutter, a computer numerical control (CNC) cutting machine, a lathe, or other suitable types of equipment. Fabrication equipment 708 can be used to fabricate at least one of metal parts, composite parts, semiconductors, circuits, fasteners, ribs, skin panels, spars, antennas, or other suitable types of parts.

Assembly equipment 710 is equipment used to assemble parts to form aerospace vehicle 600 in FIG. 6 and/or Altullara 102 in FIG. 1. In particular, assembly equipment 710 is used to assemble components and parts to form aerospace vehicle 600 in FIG. 6 and/or Altullara 102 in FIG. 1. Assembly equipment 710 also can include machines and tools. These machines and tools may be at least one of a robotic arm, a crawler, a fastener installation system, a rail-based drilling system, or a robot. Assembly equipment 710 can be used to assemble parts such as seats, horizontal stabilizers, wings, engines, engine housings, landing gear systems, and other parts for aerospace vehicle 600 in FIG. 6 and/or Altullara 102 in FIG. 1.

Without limitation, maintenance system 704 may include maintenance equipment 712. Maintenance equipment 712 can include any equipment needed to perform maintenance on aerospace vehicle 600 in FIG. 6 and/or Altullara 102 in FIG. 1. Maintenance equipment 712 may include tools for performing different operations on parts on aerospace vehicle 600 in FIG. 6 and/or Altullara 102 in FIG. 1. These operations can include at least one of disassembling parts, refurbishing parts, inspecting parts, reworking parts, manufacturing replacement parts, or other operations for performing maintenance on aerospace vehicle 600 in FIG. 6 and/or Altullara 102 in FIG. 1. These operations can be for routine maintenance, inspections, upgrades, refurbishment, or other types of maintenance operations.

Without limitation, maintenance equipment 712 may include ultrasonic inspection devices, x-ray imaging systems, vision systems, drills, crawlers, and other suitable devices. In some cases, maintenance equipment 712 can include fabrication equipment 708, assembly equipment 710, or both to produce and assemble parts that are needed for maintenance.

Product management system 700 also includes control system 714. Control system 714 is a hardware system and may also include software or other types of components. Control system 714 is configured to control the operation of at least one of manufacturing system 702 or maintenance system 704. In particular, control system 714 can control the operation of at least one of fabrication equipment 708, assembly equipment 710, or maintenance equipment 712.

The hardware in control system 714 can be implemented using hardware that may include computers, circuits, networks, and other types of equipment. The control may take the form of direct control of manufacturing equipment 706. Without limitation, robots, computer-controlled machines, and other equipment can be controlled by control system 714. In other illustrative illustrations, control system 714 can manage operations performed by human operators 716 in manufacturing or performing maintenance on aerospace vehicle 600 and/or Altullara 102 in FIG. 1. Without limitation, control system 714 can assign tasks, provide instructions, display models, or perform other operations to manage operations performed by human operators 716.

Without limitation, human operators 716 can operate or interact with at least one of manufacturing equipment 706, maintenance equipment 712, or control system 714. This interaction can occur to manufacture aerospace vehicle 600 in FIG. 6 and/or Altullara 102 in FIG. 1.

Of course, product management system 700 may be configured to manage other products other than aerospace vehicle 600 in FIG. 6 such as, without limitation, Altullara 102 in FIG. 1. Although product management system 700 has been described with respect to manufacturing in the aerospace industry, product management system 700 can be configured to manage products for other industries. Without limitation, product management system 700 can be configured to manufacture products for the automotive industry as well as any other suitable industries.

The description of the different illustrative embodiments has been presented for purposes of illustration and description and is not intended to be exhaustive or limited to the embodiments in the form disclosed. The different illustrations describe components that perform actions or operations. In an illustrative embodiment, a component can be configured to perform the action or operation described. Without limitation, the component can have a configuration or design for a structure that provides the component an ability to perform the action or operation that is described in the illustrative illustrations as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

Many modifications and variations will be apparent to those of ordinary skill in the art. Further, different illustrative embodiments may provide different features as compared to other desirable embodiments. The embodiment or embodiments selected are chosen and described in order to best explain the principles of the embodiments, the practical application, and to enable others of ordinary skill in the art to understand the disclosure for various embodiments with various modifications as are suited to the particular use contemplated.

What is claimed is:

1. A process for reducing warming of the Earth’s atmosphere; the process comprising:
receiving, in an Altullara, atmospheric data for a portion of a planned route for an aerospace vehicle;
deriving, in the Altullara, a prediction of a contrailing ice supersaturated region for an altitude for a portion of the planned route;
transforming a route planning algorithm by applying a bias derived from the prediction of the ice supersaturated region to the altitude for the portion of the planned route;
forming an Elicon route with a transformed route planning algorithm;
loading the Elicon route into a flight control computer; and
flying the aerospace vehicle along the Elicon route.

2. The process of claim 1, wherein the atmospheric data is received from a weather service.

3. The process of claim 1, further comprising deriving the bias based upon historical data for the planned route.

4. The process of claim 1, wherein the atmospheric data is received from the aerospace vehicle in proximity to the planned route.

5. The process of claim 1, further comprising deriving the prediction of a contrailing ice supersaturated region in real-time.

6. The process of claim 1, wherein the flight control computer is connected to an autopilot system executing the Elicon route.

7. The process of claim 1, further comprising updating the Elicon route in real-time.

8. The process of claim 1, wherein the route planning algorithm incorporates: aerospace vehicle performance limits, weather conditions, fuel efficiency, cruise time of the planned route, and air traffic control restrictions.

9. The process of claim 1, wherein the bias favors a climb when the altitude for the portion of the planned route is at or above 3,000 feet below a tropopause.

10. The process of claim 1, wherein the portion is for a cruise phase of the planned route.

11. The process of claim 1, wherein the Altullara is integrated into a flight planning system.

12. The process of claim 1, wherein the Altullara is a separate unit from and in communication with a flight planning system.

13. A process for reducing a formation of a contrail by an aerospace vehicle, the process comprising:
receiving, in an Altullara, atmospheric data for a portion of a planned route for an aerospace vehicle;
deriving, in the Altullara, a prediction of a contrailing ice supersaturated region for an altitude for a portion of the planned route;
transforming a route planning algorithm by applying a bias derived from the prediction of the ice supersaturated region to the altitude for the portion of the planned route;
forming an Elicon route with a transformed route planning algorithm;
loading the Elicon route into a flight control computer; and
flying the aerospace vehicle along the Elicon route.

14. The process of claim 13, further comprising deriving the bias based upon historical data for the planned route.

15. The process of claim 13, further comprising deriving the prediction of a contrailing ice supersaturated region and updating the Elicon route in real-time.

16. The process of claim 13, wherein the flight control computer is connected to an autopilot system executing the Elicon route.

17. The process of claim 13, wherein the route planning algorithm incorporates: aerospace vehicle performance limits, weather conditions, fuel efficiency, cruise time of the planned route, and air traffic control restrictions.

18. The process of claim 13, wherein the bias favors a climb when the altitude for the portion of the planned route is at or above 3,000 feet below a tropopause.

19. The process of claim 13, wherein the portion is for a cruise phase of the planned route.

20. A machine configured to reduce contrail production by an aerospace vehicle engine, wherein the machine comprises an Altullara configured to:
receive atmospheric data for a portion of a planned route for an aerospace vehicle;
derive a prediction of a contrailing ice supersaturated region for an altitude for a portion of the planned route;
transform a route planning algorithm based upon a bias derived from the prediction of the ice supersaturated region to the altitude for the portion of the planned route;
form an Elicon route with a transformed route planning algorithm; and
load the Elicon route into a flight control computer configured to fly the aerospace vehicle along the Elicon route.
